(19) United States
(12) Patent Application Publication
(10) Pub. No.: US 2006/0253474 A1
(43) Pub. Date: Nov. 9, 2006

(54) System and method for compliance profile configuration and application

(76) Inventors: Lynette I. Hotchkiss, Lake Forest, CA (US); Angela Cheek, Irvine, CA (US); Carl Sternberg, Ladera Ranch, CA (US)

Correspondence Address: TAYLOR RUSSELL & RUSSELL, P.C., 4807 SPICEWOOD SPRINGS ROAD, BUILDING TWO SUITE 250, AUSTIN, TX, 78759, US

(21) Appl. No.: 11/124,785

(22) Filed: May 9, 2005

(51) Int. Cl. G06F 7/00

(52) U.S. Cl. 707/100

(57) ABSTRACT

A system and method for specifying elections in one or more designated lender compliance profiles that include statutory election, exportation election, most favored lender election, preemption election and non-electable regulatory requirements. A set of computer-encoded compliance rules applicable to a particular financial institution is derived from a lender compliance profile. This designated set of computer-encoded and computer-executed compliance rules derived from a compliance profile may be used to determine regulatory compliance assessment of lender compliance review computer data files. The requirements of the computer-encoded compliance rules are traceable to one or more state jurisdictions, including home state, property state, and target state. The computer-encoded compliance rules are derived from statutes, regulations, case law, official interpretations, attorney general opinions, determination and other interpretive letters, administrative agency regulations, and any other sources prescribing or interpreting compliance requirements for a jurisdiction.

### BACKGROUND OF INVENTION

The present invention relates generally to systems and methods for ensuring compliance by a business entity with currently applicable Federal, state and local laws and regulations. Applying a unique business or operating profile to the business entity is one way to satisfy this requirement. The profile may comprise a set of computer-encoded compliance rules that are applied to information concerning the business entity's transactions. More particularly, using the mortgage lending industry as an exemplary embodiment, the invention is a system and method for designating values in one or more designated lender compliance profiles that identify characteristics of the financial institution to permit application of the compliance rules. The compliance rules may relate to federal preemption, statutory election under state law, statutory election under the most favored lender doctrine, interest rate exportation, and non-electable compliance requirements, and may be embodied in a designated set of computer-encoded compliance rules applicable to a particular financial institution. The designated set of computer-encoded compliance rules resulting from the designations in a compliance profile may be used to perform a regulatory compliance assessment of computer data files submitted by a lender that are subject to review for compliance with applicable requirements that differ based on the financial institution's compliance profile. The computer-encoded compliance rules are derived from statutes, regulations, case law, official interpretations, attorney general opinions, determinations and other interpretive letters, administrative agency regulations, and other sources prescribing and interpreting compliance requirements for financial institutions.

Regulatory compliance may be determined through the use of a regulatory compliance computer system that makes use of designated compliance profiles designating computer-encoded compliance rules applicable to a particular business entity and stored in a rules repository. The regulatory compliance computer system obtains compliance review data from a business entity in a computer readable format and archives the institution's compliance review computer data files into a compliance review file database. The compliance review computer data files are then compared by the computer system against the computer-encoded compliance rules designated by the application of a designated lender compliance profile, and a regulatory compliance results file is generated that delineates noncompliant loan activity in the compliance review computer data file.

Regulatory compliance requirements are prevalent in many industry sectors. Most of these regulations have been promulgated for protection of consumers. To protect consumers involved in these transactions, the Federal government as well as state and local governments have enacted laws and regulations that impose requirements on institutions and personnel involved in these businesses. These laws and regulations establish transactional standards and disclosure requirements that are enforced by Federal, state, and local agencies. As new laws, regulations, licenses, rules, and other compliance requirements have been added over time, business transactions have become more varied, complex and prone to error, resulting in an increase in exposure to liabilities for non-compliance for the businesses that are engaged in these regulated activities. For example, with the growing complexity of the financial services industry, consumers are frequently subjected to compliance errors, overcharges, and careless practices in processing loans.

Federal, state, and local regulators are conducting increasingly aggressive policing campaigns to ensure compliance by the financial services industry. These efforts have significantly increased the costs for non-compliance in terms of monetary penalties and legal expenses, as well as in terms of tarnished reputations to the financial institutions. Because of the substantial growth in Internet and multi-state activities, the potential for serious compliance violations is likely to increase along with a corresponding increase in compliance scrutiny and enforcement activities by Federal, state, and local regulatory agencies. The financial services industry faces the prospect of significant losses if they are forced to refund fees and charges, void noncompliant transactions, and pay civil and criminal penalties. To counter these potential losses, the industry will incur increased expenses associated with compliance audits and compliance policies, procedures and reporting.

To further complicate the compliance landscape, financial institutions have alternative choices of law for determining compliance requirements. A choice between different sets of laws may be available to a financial institution for application to a particular loan through the ability to make a “statutory election” to use the “most favored lender doctrine”, and to use various federal preemptions. In addition, a financial institution may have authority under federal law to “export” the interest rate related parts of the elected or applicable law from the state where the headquarters of the financial institution is located (home state) or from the state where the office of the financial institution is located (host state) into the state where the consumer resides or the collateral for the loan is located (target state).

A financial institution may elect to apply an alternative electable compliance requirement under a statutory election available under the laws of several states. Under the most favored lender (MFL) doctrine, provided for under 12 U.S.C. §85 and subsequent decisions by the United States Supreme Court, certain financial institutions are allowed to charge the interest rate permitted to competitors by the laws of the state in which the financial institution is located. Similarly, 12 U.S.C. §85 and subsequent decisions by the United States Supreme Court and interpretations of the Office of the Controller of the Currency (OCC) enable certain financial institutions to charge interest and related fees and charges in a target state as permitted by the laws of the financial institution's home state, even if that interest rate, fee, or charge would not otherwise be permitted in the target state. When exporting interest rates, a financial institution must export all permitted practices, restrictions, limitation, and prohibitions that relate to “interest” as defined from time to time by the OCC (collectively, the “interest rate provisions”). Certain financial institutions are also provided with additional federal preemption from state laws that would otherwise be applicable to some or all of the loans made by the financial institution.

Under statutory elections available in states such as Kansas, Louisiana, Maryland, Minnesota and North Carolina, a lender may choose between various state laws potentially applicable to certain loans. Typically, state laws dictate which rules apply to a loan transaction. But there are a few situations in which the law provides that even though one law would typically apply to the loan, if the lender and the borrower agree to apply a different specified law, they may do so, and the elected law now becomes the governing law for the transaction. This is known as statutory election. For example, Kansas has a Usury Statute that applies to first lien loans. The Kansas Uniform Consumer Credit Code (UCCC) applies to second lien loans. Kansas law allows the lender to contract with the borrower, in the promissory note, to use the Kansas UCCC for first lien loans, if the lender and borrow agree. See Table 1 for the financial institutions that may apply a statutory election.

The MFL doctrine allows certain financial institutions to use a law that applies to one of financial institution's competitors in the home state, rather than the law that would otherwise apply to the financial institution, for determining the applicability of permitted practices, restrictions, and limitations relevant to the determination of the interest rate of a loan. For example, a commercial bank in Ohio is subject to the Ohio Bank Act and a savings bank in Ohio is subject to the Ohio Savings and Loan Act, but under the MFL doctrine, the savings bank may use the interest rate authorized by the Ohio Bank Act. Thus, under the MFL doctrine and supporting federal law, although national banks and federal savings banks would otherwise be required to lend using the low interest rate prescribed by the federal laws applicable to them, they may borrow the interest rate authority from any competing lender in the state in which they are located. For example, if the National Bank of Ohio has its headquarters in Ohio, and the National Bank of Ohio has the option of making loans either using the federal interest rate or the interest rate that any competitor lending in Ohio is using. However, upon choosing this option, the National Bank of Ohio would then also be subject to all the rules that are material to the determination of interest rate that the competing lender must follow. See Table 1 for the financial institutions that may apply the MFL doctrine.

The authority to export interest rate provisions under federal law enables certain lending institutions to apply the interest rate provisions of the law in their home state rather than the interest rate provisions of the law in a target state into which the financial institutions provide financial services. For example, the National Bank of Ohio may choose to lend money under the Ohio Savings Bank Act. If the National Bank of Ohio chooses to export the interest rate provisions of its home state of Ohio, then the Ohio state interest rate provisions applicable to the National Bank of Ohio (taking into consideration its MFL election to use the Ohio Savings Bank Act) control and the interest rate provisions of the target state no longer apply. For example, if Missouri does not allow a loan origination fee to exceed two percent of the loan amount and there is no similar restriction in Ohio, when providing financial services in Missouri, the National Bank of Ohio may “export” Ohio's lack of any restriction to Missouri, and would not be subject to the Missouri limitation. When exporting interest rate related laws from a home state, a lender must also export all terms that are material to the exported interest rate, including fees for credit extension, periodic rates, late fees, insufficient funds fees, annual fees, etc. See Table 1 for the financial institutions that may apply the exportation rule.

TABLE 1

| | | MOST | |
|---|---|---|---|
| | STATUTORY | FAVORED | EXPOR- |
| INSTITUTION | ELECTION | LENDER | TATION |
| Federal Savings Bank | Yes | Yes | Yes |
| National Bank | Yes | Yes | Yes |
| Federal Credit Union | Yes | No | No |
| State Chartered Bank | Yes | Yes | Yes |
| State Chartered Savings | Yes | Yes | Yes |
| Associations (includes | | | |
| S&Ls) | | | |
| State Chartered Credit | Yes | No | No |
| Unions | | | |
| State Licensed Non- | Yes | No | No |
| Depository Institutions | | | |

In order to satisfy regulatory compliance requirements, institutions offering financial services to consumers have attempted to audit transaction compliance on a manual basis. This approach results in a tedious, time-consuming and costly process that allows only a small statistical sample of transaction applications to be examined for compliance with requirements. The results of this process are also oftentimes inconsistent due to factors such as varying degrees of understanding, differences in interpretation of the laws and regulations, the applicability of various and differing compliance requirements based on the financial institution's compliance profile, and human processing errors. As competition increases, there is a strong need to reduce the cost of adherence to regulatory compliance standards as well as to reduce penalties for failure to meet compliance requirements. For example, some mortgage companies have attempted to employ risk management techniques, which have proved inadequate as a solution to compliance and related liability problems.

While the mortgage lending industry may be more regulated than many other industries, the compliance difficulties are also encountered in many other areas. Other applications where automated compliance assessment and compliance profile configuration and application would reduce costs and speed transaction processing may include automobile and other consumer loans, leasing transactions, as well as regulatory requirements for other industries, such as the healthcare and environmental-related industries.

In response to the increased regulatory burden, financial institutions are increasingly relying on automated computer-based methods for ensuring regulatory compliance of their transaction data files in their data repositories. One of the most critical aspects of these automated systems is the application of computer-encoded compliance rules from regulatory requirements of statutes, regulations, case law, official interpretations, attorney general opinions, determination and other interpretive letters, administrative agency regulations, and any other sources prescribing or interpreting compliance requirements. These derived computer-encoded compliance rules must provide an accurate representation of the compliance requirements as they relate to the unique compliance profile of the identified business entity and must be traceable back to relevant compliance requirements. One or more sets of these regulatory compliance rules must oftentimes be applied to lender transaction data files, when considering multi-variable effects of statutory election, MFL doctrine, interest rate exportation, and preemption. These computer-encoded compliance rule sets form the foundation upon which the accuracy, integrity and reputation of an associated regulatory compliance system depend.

### SUMMARY OF THE INVENTION

The present invention provides a system and method for configuring and applying computer-encoded and computer-executed rule sets to a business entity based on the entity's unique compliance profile. For example, for lenders in the mortgage lending industry, the invention provides a system and method for configuring, applying and executing computer-encoded rule sets that incorporate the requirements imposed by the lenders business organization model (e.g., a national charter, a state charter, a state license, etc.) and choices concerning statutory elections, the MFL doctrine, exportation of interest rate provisions, and available preemptions; A lender's compliance profile may comprise a combination. of the lender's business organization model and choices the lender makes concerning permitted statutory elections, MFL elections, exportation elections, and preemption elections. The rules contained in these computer-encoded rule sets are computer-encoded and computer-executed compliance rules for a regulatory compliance system that provide an accurate representation of the regulatory requirements and are traceable back to relevant compliance sources. The computer-encoded and computer-executed compliance rules provide compliance assurance for the consumer, the financial services industry, Federal, state, and local regulatory agencies, and the investment community.

Using an exemplary application of the present invention to the mortgage lending industry, computer-encoded compliance rule sets are defined by a lender's unique compliance profile and executed by a regulatory compliance system to verify that all compliance review data for every transaction adheres to the most current Federal, state, local and other compliance requirements. The compliance profile impose requirements based on lender entity type, home state, federal preemption election, state statutory elections, state most favored lender elections, state exportation elections and non-electable regulatory requirements. A particular lending institution may rely on a selection of computer-encoded rule sets for application to compliance review computer files under varying circumstances.

Requirements imposed on the mortgage lending industry may comprise the following:
Truth-In-Lending Act (TIL) Requirements
Real Estate Settlement Procedures Act (RESPA)
Home Mortgage Disclosure Act (HMDA)
Office of Foreign Asset Control (OFAC)
Home Ownership and Equity Protection Act (HOEPA)
Originator and Lender Licensing Requirements
State Regulatory Laws Regulating Financial Transactions
State and Local High Cost Calculations Requirements
Predatory Lending Rules and Regulations
State Consumer Protection Laws and Regulations

Considering the mortgage lending industry as an example, the computer-encoded compliance rules are executed by a regulatory compliance system to ensure that loan data is free of such things as licensing violations, calculation errors, violations of interest/usury rate limitations, finance charge restrictions, payment terms and restrictions, loan term limitations, and fee restrictions and limitations. These include, but are not limited to, licensing requirements, high-cost loan calculations and restrictions, interest rate limitations, interest collection and accrual, payment terms and limitations, loan term and amortization restrictions, restricted/prohibited charges and fees, late charge limitations, and prepayment penalty limitations that may lead to violations of applicable Federal, state and local requirements. The regulatory compliance system also handles the variations imposed by the use of statutory election, the MFL doctrine, exportation of interest rate provisions, and available preemptions. As a result of the computer-encoded and computer-executed compliance rules, areas of noncompliance are identified as exceptions and presented to the processing agent by the regulatory compliance system for corrective action.

Regulatory compliance determination is accomplished by applying a set of computer-encoded and computer-executed compliance rules to the compliance review data for each transaction. A regulatory compliance system compares compliance review files with the computer-encoded rule sets stored in a compliance rules repository, which are applied based on the lender's compliance profile, and generates a results file that documents areas of compliance and noncompliance with the computer-encoded compliance rules. A regulatory compliance system for use with the present invention is disclosed in U.S. patent application Ser. No. 10/249,784 entitled SYSTEM AND METHOD FOR AUTOMATED LOAN COMPLIANCE ASSESSMENT, filed on May 7, 2003, which is incorporated herein by reference. A regulatory rules repository generation and maintenance system for use with the present invention is disclosed in U.S. patent application Ser. No. 10/710,866 entitled SYSTEM AND METHOD FOR REGULATORY RULES REPOSITORY GENERATION AND MAINTENANCE, filed on Aug. 9, 2004, which is incorporated herein by reference.

An embodiment of the present invention is a computer-implemented method for compliance profile configuration and application comprising the steps of designating a compliance profile comprising one or more options, deriving a set of computer-encoded compliance rules based on the one or more options in the compliance profile, assessing regulatory compliance of a lender compliance review file in a compliance assessment computer system by automatically comparing the lender compliance review file with the designated set of computer-encoded compliance rules stored in a regulatory compliance rules repository, producing a compliance assessment result file indicating subject areas in the compliance review file that are compliant and noncompliant with the derived set of computer-encoded compliance rules, and displaying the subject areas that are compliant and noncompliant to a user. The method may further comprise selecting the one or more options in the compliance profile from the group of options consisting of lender entity type, home state, statutory election, exportation, most favored lender and preemption. The lender entity type option may be selected from the group consisting of a national bank, a federal savings bank, a federal credit union, a state chartered bank, a state chartered savings bank, a state chartered savings and loan association, a state chartered credit union, and a non-depository licensed lender. The home state option may comprise the state where the principal office of a depository institution is located. The statutory election option may comprise a designated statutorily electable act allowable under a state law. The exportation option may comprise a designated interest rate provision from a home state of a depository institution for determining an exportable chargeable interest rate in a target state. The most favored lender option may comprise a designated preferred interest rate provision available to applicable depository institutions that makes available to the applicable depository institutions interest rates that are available to other lending institutions within a state. The preemption option may comprise a designated exemption available to national banks and federal savings associations from certain types of state laws in. lending and deposit taking activities. The lender entity type and home state options may determine other options that are available to a lender.

The step of deriving a set of computer-encoded compliance rules may comprise the step of deriving computer-encoded compliance rules from elected statutorily electable acts and applicable unelectable acts under state law. The step of deriving a set of computer-encoded compliance rules may comprise the step of deriving computer-encoded compliance rules from law in a lender's home state for determining a chargeable interest rate under the most favored lender doctrine. The derived computer-encoded compliance rules may be derived from the terms of the designated most favored lender elected home state act that are material to the determination of the chargeable interest rate. The step of deriving a set of computer-encoded compliance rules may comprise the step of deriving computer-encoded compliance rules from compliance requirements of a home state that are material to determining an exportable chargeable interest rate applicable in a target state. The step of deriving a set of computer-encoded compliance rules may comprise the step of deriving computer-encoded compliance rules from a preemption election to override certain types of laws in lending and deposit taking activities. The method, wherein, if a statutory election option in the designated compliance profile is elected and a most favored lender option in the designated compliance profile is not elected, the derived set of computer-encoded compliance rules may comprise all computer-encoded compliance rules derived from unelectable and elected electable acts of a property state. The method, wherein, if a statutory election option in the designated compliance profile is not elected and a most favored lender option in the designated compliance profile is not elected, the derived set of computer-encoded compliance rules may comprise a default computer-encoded compliance rule set derived from acts of a property state. The method, wherein, if a statutory election option in the designated compliance profile is elected, a property state is the same as a home state, and a most favored lender option in the designated compliance profile is elected, the derived set of computer-encoded compliance rules may comprise all computer-encoded compliance rules derived from all acts of a property state, except only most favored lender rules derived from an elected act and non most favored lender rules derived from nonelectable and unelected electable acts. The method, wherein, if a statutory election option in the designated compliance profile is not elected, a property state is the same as a home state and a most favored lender option in the designated compliance profile is elected, the derived set of computer-encoded compliance rules may comprise a default computer-encoded compliance rule set derived from acts of the property state. The method, wherein, if a statutory election option in the designated compliance profile is elected for a property state, the property state is not the same as a home state, a most favored lender option in the designated compliance profile is elected, and an exportation option in the designated compliance profile is not elected, the derived set of computer-encoded compliance rules may comprise all computer-encoded compliance rules derived from unelectable and elected acts of the property state. The method, wherein, if a statutory election option in the designated compliance profile is elected, a property state is not the same as a home state, a most favored lender option in the designated compliance profile is elected, an exportation option in the designated compliance profile is not elected, and the statutory election option in the designated compliance profile is not elected for the property state, the derived set of computer-encoded compliance rules may comprise a default computer-encoded compliance rule set derived from acts of the property state. The method, wherein, if a statutory election option in the designated compliance profile is elected, a property state is not the same as a home state, a most favored lender option in the designated compliance profile is elected, an exportation option in the designated compliance profile is elected, and the statutory election option in the designated compliance profile is for the home state and a target state is elected, the derived set of computer-encoded compliance rules may comprise nonexportable computer-encoded compliance rules and exportable computer-encoded compliance fee rules derived from nonelectable and elected acts of the property state, most favored lender computer-encoded compliance rules derived from an elected act of the home state, and all non most favored lender exportable computer-encoded compliance fee rules derived from nonelectable and unelected electable acts of the home state. The method, wherein, if a statutory election option in the designated compliance profile is elected, a property state is not the same as a home state, a most favored lender option in the designated compliance profile is elected, an exportation option in the designated compliance profile is elected, and the statutory election designation is for the home state and not for a target state, the derived set of computer-encoded compliance rules may comprise nonexportable computer-encoded compliance rules and exportable computer-encoded compliance fee rules derived from all acts in the property state, most favored lender computer-encoded compliance rules derived from an elected act in the home state, and all non most favored lender exportable computer-encoded compliance rules and non most favorable lender exportable computer-encoded compliance fee rules derived from nonelectable and unelected electable-acts from the home state. The method, wherein, if a statutory election option in the designated compliance profile is elected, a property state is not the same as a home state, a most favored lender option in the designated compliance profile is elected, an exportation option in the designated compliance profile is elected, and the statutory election option is not for the home state and for a target state, the derived set of computer-encoded compliance rules may comprise nonexportable computer-encoded compliance rules and exportable computer-encoded compliance fee rules derived from nonelectable and elected acts of the property state, and all exportable computer-encoded compliance rules and exportable computer-encoded compliance fee rules derived from all acts of the home state. The method, wherein, if a statutory election option in the designated compliance profile is not elected, a property state is not the same as a home state, a most favored lender option in the designated compliance profile is elected, and an exportation option in the designated compliance profile is not elected, the derived set of computer-encoded compliance rules may comprise a default rule set of computer-encoded compliance rules derived from acts of the property state. The method, wherein, if a statutory election option in the designated compliance profile is not elected, a property state is not the same as a home state, a most favored lender option in the designated compliance profile is elected, and an exportation option in the designated compliance profile is elected, the derived set of computer-encoded compliance rules may comprise nonexportable computer-encoded compliance rules and exportable computer-encoded compliance fee rules derived from all acts in the property state, and all exportable computer-encoded compliance rules and exportable computer-encoded compliance fee rules derived from all acts in the home state. The method may further comprise assigning a lender default profile and lender override profiles to a lender based on loan characteristics. The embodiment includes a computer-readable medium containing instructions for controlling a computer system to implement the method described above.

Another embodiment of the present invention is a computer-based system for compliance profile configuration and application comprising means for designating a compliance profile configuration comprising one or more options, means for deriving a set of computer-encoded compliance rules based on the one or more options in the compliance profile, means for assessing regulatory compliance of a lender compliance review file in a compliance assessment computer system by automatically comparing the lender compliance review file with the designated set of computer-encoded compliance rules stored in a regulatory compliance rules repository, means for producing a compliance assessment result file indicating subject areas in the compliance review file that are compliant and noncompliant with the derived set of computer-encoded compliance rules, and a user interface for displaying the subject areas that are compliant and noncompliant to a user. The system, wherein the one or more options in the designated compliance profile may be selected from the group of options consisting of lender entity type, home state, statutory election, exportation, most favored lender and preemption. The system, wherein the lender entity type option may be selected from the group consisting of a national bank, a federal savings bank, a federal credit union, a state chartered bank, a state chartered savings bank, a state chartered savings and loan association, a state chartered credit union, and a non-depository licensed lender. The system, wherein the home state option may be elected from the state where the principal office of a depository institution is located. The system, wherein the statutory election option may be an elected statutorily electable act allowable under a state law. The system, wherein the exportation option may be an elected interest rate provision from a home state of a depository institution for determining an exportable chargeable interest rate in a target state. The system, wherein the most favored lender option may be an elected preferred interest rate provision available to applicable depository institutions that makes available to the applicable depository institutions interest rates that are available to other lending institutions within a state. The system, wherein the preemption option may be an elected exemption available to national banks and federal savings associations from certain types of state laws in lending and deposit taking activities. The system, wherein the elected lender entity type and home state options may determine other options that are available to a lender. The system, wherein the means for deriving a set of computer-encoded compliance rules may comprise a compliance profile configuration processing function for customizing the designated set of computer-encoded compliance rules based on the designated compliance profile. The system, wherein the means for assessing regulatory compliance of a lender compliance review file may comprise a state reviewer for executing the compliance profile configuration processing functions, and a rule engine for executing get fees and fees not allowed functions. The system may further comprise acts, rules and fee objects categorized and identified according to statutory elections, exportation, most favored lender doctrine and preemption.

Yet another embodiment of the present invention is a computer-implemented method for compliance profile configuration and application comprising the steps of reading a compliance profile associated with a lender compliance review file for determining lender entity type election, home state election, statutory elections, exportation elections, most favored lender elections and preemption elections, processing the compliance profile for selecting a computer-encoded compliance rule set derived from home state acts, property state acts, target state acts, and preemptions of acts determined by the compliance profile, accessing the computer-encoded rules set from a compliance rules repository, comparing the lender compliance review file with the computer-encoded compliance rule set in a compliance assessment computer system, generating a compliance assessment result file for indicating subject areas of compliance and noncompliance, and displaying the subject areas of compliance and noncompliance to a user. The method, wherein the step of processing the compliance profile may further comprise the steps of accessing rules sets based on the statutory election if a no most favored lender election is determined, accessing rule sets based on the statutory election if a most favored lender election is determined and a property state is the same as a home state, accessing rule sets based on whether a statutory election is made for a property state if exportation is not elected, if a most favored lender election is determined and the property state is not the same as the home state, accessing rule sets based on whether a statutory election is made in a home state and a target state, if exportation is elected, if a most favored lender election is determined and the property state is not the same as the home state, and accessing rule sets based on whether exportation is elected, if a statutory election is made in a target state, if a most favored lender election is determined and the property state is not the same as the home state. The method, wherein the step of reading a compliance profile for determining a statutory election may comprise the step of designating a statutorily electable act allowable under a state law. The method, wherein the step of reading a compliance profile for determining a most favored lender election may comprise the step of designating a home state law for determining a chargeable interest rate in a loan. The method, wherein the step of reading a compliance profile for determining an exportation election may comprise the step of reading a compliance profile for designating a home state law for determining an exportable chargeable interest rate and other exportable interest rate provisions, and applying the rate and provisions in a target state. The method, wherein the step of reading a compliance profile for determining a lenders election to take advantage of preemptions available to the lender may comprise the step of designating computer-encoded compliance rules derived from the preemptions elected. The embodiment includes computer-readable medium containing instructions for controlling a computer system to implement the method described above.

### DEFINITION OF TERMS

Act: A Federal, state or local law, statute, regulation, or other authoritative source that imposes regulatory compliance requirements on a particular business industry.
Closed-End Loan: A loan where the amount of the debt is fixed at the time the loan is closed and cannot be increased during the life of the loan.
Compliance Assessment Result File: A computer data file that contains the result of an automated regulatory compliance review determined by a comparing a lender compliance review file with a designated set of computer-encoded compliance rules in a computer system.
Compliance Profile: A business or operating profile from which a business entity's compliance reviews will be executed. For a lender in the mortgage industry, the lender's primary lender entity type, home state, statutory elections, exportation, most favored lender and preemption choices are stored here.
Default Profile: The base profile from which a business entity's compliance reviews will be executed. For a lender in the mortgage industry, the lender's primary lender entity type, home state, statutory elections, exportation, and preemption choices are stored here.
Default Rule Set: The standard set of computer-encoded compliance rules associated with a compliance profile without alternative elections.
Depository Institution: Any financial institution authorized to take deposits. This may include banks, savings and loan associations, savings banks, and credit unions.
Electable Act: An act available to a business entity through statutory election. An example of this would be the Maryland Credit Grantor Law for subordinate lien closed-end loans secured by real property in Maryland.
Elected Act: An act available to a lender through statutory election that is elected by the lender for a particular loan type.
Exportable Rule: A substantive rule that relates to interest that may be charged in a loan, as the term “interest” is defined by the Office of the Comptroller of the Currency (OCC). A lender may export all interest related rules from its home state. Examples of these types of rules would be: Late Charges, Grace Periods, Prepayment Penalties, and fees that are considered interest under the OCC definition.
Exportable Fees Rule: A rule that analyzes fees charged in the loan. If a lender exports the “interest” from its home state, the exportable fees rule will be evaluated in the home state and only those fees in the rule that the OCC designates as exportable and as part of the interest rate in the home state (“interest”) will be used. In the same loan, the exportable fees rule will be evaluated in the target state, but only those fees designated as “non-interest” in the evaluation of that rule will be used.
Exportation: An option that permits a depository institution to apply interest-related rules from its home state to a target state, thereby overriding the target state interest-related rules.
Federal Preemption: An option that permits a business entity to ignore state laws while complying only with federal laws.
Home State: State where a depository institution's headquarters or principal office is located.
Host State: State where a depository institution has a branch office or other presence sufficient to permit the use of that state's interest rate authority.
Junior Lien: A lien that is subordinate to a prior lien. It is the same as a subordinate lien.
Lender Compliance Review File: A lender data file that contains information concerning a particular loan to a particular borrower that is compared with a designated set of computer-encoded regulatory compliance rules in a regulatory compliance computer system for determining whether the loan is in compliance with regulatory requirements.
Lender Entity Type: A lender designation indicating the form of business organization of a lender. Examples of a lender entity type include a national bank, a federal savings bank, a federal credit union, a state chartered bank, a state chartered savings bank, a state chartered savings and loan association, a state chartered credit union, and a non-depository licensed lender.
Licensed Lenders: Non-depository institutions such as mortgage companies and mortgage lenders.
Lien: A claim, encumbrance, or charge on property for payment of some debt, obligation or duty.
MFL: “Most Favored Lender”—applicable to federal and state chartered depository institutions, such as national and state banks and savings and loan associations. Allows the lending entity to use preferred interest rules and rates.
MFL Act: An act available for a depository institution to elect through the MFL doctrine.
MFL Lender: An attribute of the lender entity type specified for the customer profile (default or override profile).
MFL Rule: A rule containing an “interest” component or that is “material to the determination of the permitted interest.”
Non-Depository Institution: Financial institutions that do not take deposits, such as mortgage companies and mortgage lenders.
Non-Electable Act: An act that either applies or does not apply to a lender in a state. The lender does not have the choice to elect to lend or not to lend under the act. The act applies to the lender because of the lender's license or charter, or the type of loan transaction, or applies to the broker in a wholesale loan.
Non-Exportable Rule: A substantive rule that does not contain an “interest” component. An example of this would be a rule that prohibits a balloon payment.
Non-MFL Rule: A rule that does not contain an “interest” component and is not “material to the determination of the permitted interest.”
OCC: The Office of the Comptroller of the Currency, which charters, regulates and supervises national banks.
Open-End Loan: A loan allowing a borrower to receive additional advances of principal from the lender during the life of the loan, up to a specified credit limit.
Override Profile: An alternate customer profile containing an application rule for the profile as well as an alternate selection of lender entity type, home state (if applicable), statutory elections, exportation, and preemption choices.
Preemption: The ability of national banks and federal savings associations to override certain types of state laws in lending and deposit taking activities.
Property State: State where the property subject to the loan is located. It is the same as a target state when the property state is not the home state.
Statutory Election: An option that permits the lender to select which an act(s) the lender will comply with when there are similar or overlapping laws in the property state, target state, or home state.
Subprime Mortgage Loan: Mortgage loans for persons with blemished or limited credit histories.
Target State: State, other than the home state, into which a lender is making a loan. For example, in a mortgage loan, the state where the property subject to the loan is located is the target state. For mortgage loans, it is the same as property state when the property state is not the home state.
Unelected Electable Act: An act available to a lender through statutory election that is not elected by the lender.
Unelected MFL Act: An act available for a depository institution to elect through the MFL doctrine that is not elected by the depository institution.

### BRIEF DESCRIPTION OF DRAWINGS

These and other features, aspects and advantages of the present invention will become better understood with regard to the following description, appended claims, and accompanying drawings wherein:

FIG. 1 shows a functional flow diagram for compliance profile configuration processing;

FIG. 2 shows default and override lender profiles used for determining designated sets of regulatory compliance rules available to the customer;

FIG. 3 shows a flow diagram for a MFL lender determination from a default or override profile;

FIG. 4 shows a flow diagram for statutory elections available to lender that is not a MFL lender;

FIG. 5A shows a flow diagram for statutory elections available to a lender that is a MFL lender where the property state is the same as the home state;

FIG. 5B shows a flow diagram for statutory elections and exportation elections available to a lender that is a MFL lender where the property state is not the same as the home state;

FIG. 6 shows an XML representation of a lender identity;

FIG. 7 shows an XML representation of a data package;

FIG. 8 shows an XML representation of an act;

FIG. 9 shows an XML representation of a rule header;

FIG. 10 shows an XML representation of a fee.

FIG. 11 lists the acts that may be available as the basis for compliance review for the state of Maryland; and

FIG. 12 lists the acts that may be available as the basis for compliance review for the state of Ohio;

### DETAILED DESCRIPTION

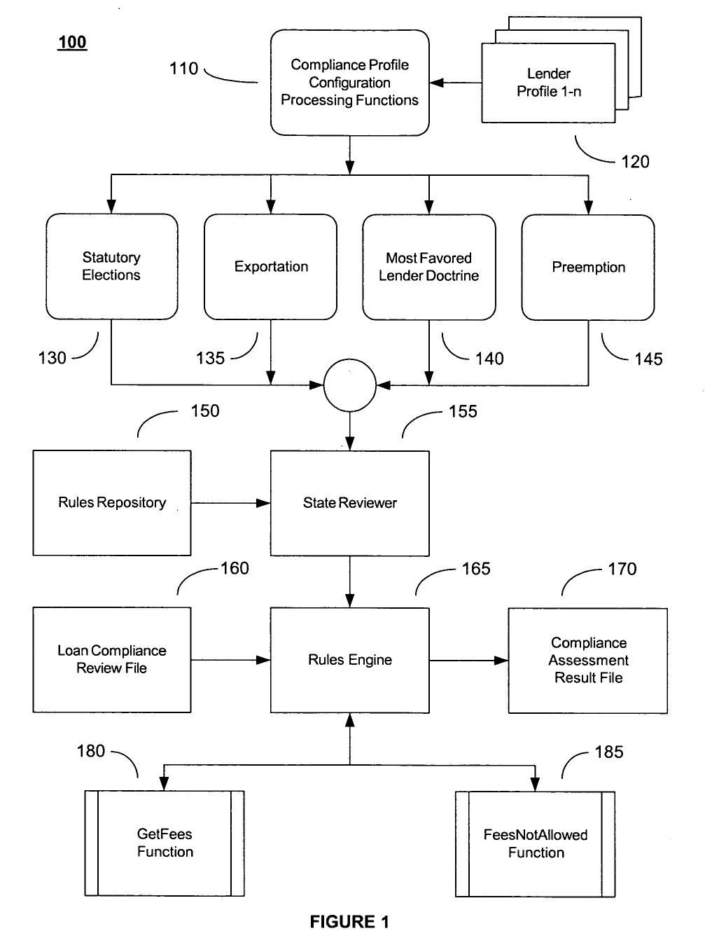

Turning to FIG. 1, FIG. 1 shows a functional flow diagram 100 for compliance profile configuration processing. A lender profile 120 contains information about a lender's selections regarding entity type, statutory election 130, most-favored-lender (MFL) doctrine election 140, exportation 135, preemption 145 and lender locations such as home state. The information contained in the lender profile 120 is applied by compliance profile configuration processing functions 110 for customizing the way computer encoded rules are applied to a loan compliance review file 160 under review by an automated loan review process by a state reviewer 155. The compliance profile configuration processing functions 110 include statutory elections 130, exportation 135, MFL doctrine 140 and preemption 145. The compliance profile configuration processing functions 110 are executed by the state reviewer 155, and the GetFees 180 and FeesNotAllowed 185 functions are executed within a rules engine 165, as determined by the state reviewer 155. A designated rules set for determining regulatory compliance, comprising a designated set of computer-encoded compliance rules stored in a rules repository 150, is a function of the compliance profile configuration processing functions 110 driven by the lender profile 120 and the data contained in a lender compliance review file 160. The result of a compliance review by the rules engine 165 is stored in a compliance assessment result file 170, for transmission and display on a user interface.

The configuration profile configuration processing functions 110 provides data validation for required fields, including the property state. Prior to initiating a state rules review by the state reviewer 155, the applicable lender entity type is designated from a lender profile 120 if the lender has specified any override profiles. If a loan is to be reviewed, the compliance profile configuration processing functions 110 looks for a lender entity override in the lender profile. If an application rule for an override profile evaluates as true, that override profile becomes the controlling profile for review. The specified lender entity type and home state override the operative values for review. If either there are no override profiles or none of the override application rules apply to the loan, the default profile becomes the controlling profile for the review and the specified lender entity type and home state (if applicable) become the operative values.

To enable the compliance profile configuration processing functionality, acts, rules and fees objects must be categorized and identified according to statutory electability, exportability, and whether or not the object is MFL-related. Acts must be flagged as to electability by the lender. Acts relating to the MFL doctrine must also be identified. These acts are electable only by MFL lenders, such as National Banks, State Banks, etc. These institutions may also elect non-MFL electable acts, as can non-MFL lenders, such as state licensed lenders and Federal and state credit unions. Acts that apply to loans for all lenders are nonelectable. Each of these electability options is mutually exclusive. Rules must be flagged as to their exportability. Exportable rules are interest-related and an MFL status further refines a rule's applicability. Fee rules that contain exportable fees are identified as exportable-fees rules. Exportable fees rules where there is a “paid-to” restriction are labeled as exportable-paid-to-fees rules. Fees must be flagged as to their exportability.

Statutory Election Option

The authority for a lender to select between multiple state statutes comes from the specific state law. For example, the Maryland Credit Grantor Closed End Credit Provisions state that the lender may choose to make the loan under this act, but that the lender and the borrower must reflect this choice in the written loan agreement. If the lender does not make such a choice, then the loan would be subject either to the Maryland Interest Act (for first lien loans) or the Maryland Secondary Mortgage Loan Law (for subordinate lien loans). All lenders have the option to make a statutory election 130, if it is available under state law.

Statutory election 130 enables a lender to choose between a group of laws in a particular state for certain loan types or categories. Typically, state laws dictate which laws apply to a particular loan transaction. However, the laws of some states permit the parties to the loan agreement to choose which law will apply to the loan. This is known as statutory election 130 and the state statutes between which the lender and the borrower may choose are known as “Electable Acts”. The automated compliance assessment system limits the choices available to the parties to this group of “Electable Acts” for a particular state.
Example: The Kansas Usury Statute applies to first lien loans. The Kansas Uniform Consumer Credit Code applies to all subordinate lien loans. Kansas law authorizes the lender to choose the Kansas Uniform Consumer Credit Code for all of its first lien loans, if the lender and the borrower agree to do so in the written loan agreement.
   Currently, there are five states in which statutory election 130 is available: Kansas, Louisiana, Maryland, Minnesota, and North Carolina.

If a lender makes a statutory election 130, the automated compliance assessment system will run all of the rules under the elected act and all of the rules under the nonelectable acts, if applicable. The system will not run any rules under the unelected electable acts. The statutory election option is available to all financial institutions. The definitions that apply to the statutory election option include Electable Act, Elected Act, NonElectable Act and Unelected Electable Act.

Most Favored Lender Doctrine Option

The authority for the most favored lender doctrine 140 is found in federal statutes, 12 C.F.R. §7.4001(1)(b) for national associations (national banks), 12 C.F.R. §560.2(a)(12), 12 C.F.R. §560.110(b) for federal savings associations, and 12 U.S.C. 1831d for state chartered depository institutions insured by the FDIC. In addition, “wild card” statutes in certain states provide for a most favored lender doctrine for institutions chartered by that state.

The most favored lender doctrine 140 authorizes certain types of lenders, including federal savings banks, national banks, state chartered banks and state chartered savings associations, to charge borrowers the interest rate allowed by the laws of the state where the lender is “located,” rather than apply the law that would otherwise apply to the loan. Federal law authorizes national banks and federal savings banks and associations to charge 1% over the discount rate on 90 day commercial paper in effect at the Federal Reserve Bank in the Federal Reserve District in which the institution is located, referred to as the discount rate, or in the alternative, to charge interest at the rate that may be charged by any other lender in the state in which the insured depository institution's principal office is located referred to as the home state. State-chartered depository institutions insured by the Federal Deposit Insurance Corporation are given “parity” with these federally chartered entities, and thus are also permitted to charge 1% over the discount rate or to borrow the interest rate authority from any other lender in the state. In addition, certain states have “wild card” statutes that allow insured depository institutions chartered in the state to use the interest rate authority of any competing lender “located” in that state. If such a “wild card” statute exists in the state that chartered the insured state-chartered depository institution, the insured state-chartered depository institution may elect to use the interest rate authority under the statute that provides the most favorable results to the insured state chartered depository institution—the most favored lender rate. The insured state-chartered depository institution may use this authority to gain parity under the most favored lender (MFL) doctrine 140.
Example: A commercial bank chartered by the state of Ohio is subject to the Ohio Bank Act. A savings bank chartered by the state of Ohio is subject to the Ohio Savings and Loan Act. Under the MFL doctrine, the Ohio state chartered savings bank may elect to use the Ohio Bank Act.
Example: The National Bank of Ohio, with a national association charter, has its principal office in Ohio. Thus, Ohio is the national bank's home state. Since the National Bank of Ohio is a national association, it is governed by federal law, so the national association may charge the federal interest rate authorized under Section 85 of the National Bank Act, 12 U.S.C. §85. Although Section 85 of the National Bank Act contains no additional fee or late charge restrictions, the national bank would not be able to charge an interest rate over 1% above the discount rate.
Under the MFL doctrine 140, rather than using the federal interest rate of 1% over the discount rate, the National Bank of Ohio may charge interest at the maximum rate permitted to any Ohio state-chartered depository institution or Ohio licensed lender. If Ohio law permits different interest charges on specified classes of loans, a national bank using the MFL doctrine 140 to make such loans will be subject only to the provisions of the Ohio law relating to that class of loans that are material to the determination of the permitted interest.

If the home state is the same as the property state and the insured depository institution does not elect to use the MFL doctrine 140, the compliance assessment system will run a default rule set for the property state, which, here, is the same as home state, since the MFL functionality is not active. If the insured depository institution is a state chartered institution, the compliance assessment system will apply the appropriate state law to the loan for both interest rate authority and for non-interest related issues. If the insured depository institution is a federally chartered institution, the compliance assessment system will apply the interest rate of 1% over the discount rate, and will apply any other generally applicable non-interest related rules to the loan.

If the insured depository institution has a MFL doctrine election available and elects to use it, the compliance assessment system will (1) run only the MFL rules under the elected MFL act and will not run the non-MFL rules under the elected MFL act; (2) run only the non-MFL rules under the nonelectable acts (if applicable) and under the unelected MFL electable acts (if applicable). The definitions that apply to the MFL doctrine option include Home State, Property State, MFL Act, Elected Act, Unelected MFL Act, MFL Rule and Non-MFL Rule.

Exportation Option

Interest rate charges are governed by Sections 501 and 528 of the Depository Institutions Deregulation and Monetary Control Act of 1980 (DIDMCA) (12 U.S.C. §1735f-7a and 12 U.S.C. §1735f-7a note), Section 85 of the National Bank Act (12 U.S.C. §85) and 12 C.F.R. §7.4001(a) for national associations (national banks); Section 27 of the Federal Deposit Insurance Act (12 U.S.C. §1831d) and FDIC Opinion No. 10 (63 Fed. Reg. 19258) for insured state-chartered depository institutions; and Section 4(g) of the Home Owners' Loan Act of 1933 (12 U.S.C. §1463(g)) and 12 C.F.R. §560.110 for federal savings associations. A lender's authority to export “interest” 135 from its home state also is derived from the above statutes and regulations and a line of court cases beginning with Tiffany v. National Bank of Missouri, 85 U.S. 409 (1873), Greenwood Trust Co. v. Massachusetts, 971 F. 2d 818 (15s Cir. 1992) cert. denied, 113 S. Ct. 974 (1993), Marquette Nat'l Bank v. First Omaha Serv. Corp., 439 U.S. 299 (1978), and the United States Supreme Court decision in Smiley v. Citibank (South Dakota), N.A., 116 S. Ct. 1730 (1996). Federal credit unions, state chartered credit unions, and state licensed non-depository institutions do not have the authority to export “interest” 135.

Federal law, regulations, and agency opinions authorize certain lenders to charge “interest” authorized by the state where the lender is located no matter where the borrower resides or the real property securing the loan is located. In other words, an authorized lender may export “interest” 135 from the state in which it is located (home state) to any other state.
Example: The National Bank of Ohio is a national association chartered under federal law with its principal office in Ohio (home state). The National Bank of Ohio chooses to lend under the Ohio Savings Bank Act. All of the items and fees that are defined as “interest” under 12 C.F.R. §7.4001 (a) for national associations (national banks), FDIC Opinion No. 10 (63 Fed. Reg. 19258) for insured state-chartered depository institutions, and 12 C.F.R. §560.110 for federal savings associations may be charged by the National Bank of Ohio in all fifty states, if such fee or item is authorized under the Ohio Savings Bank Act. Assume that the National Bank of Ohio makes a loan secured by a borrower's dwelling on real property in Missouri. If Missouri law does not allow a loan origination fee to exceed 1% of the loan amount, but there is no similar restriction under the Ohio Savings Bank Act, the National Bank of Ohio may export the loan origination fee allowed under the Ohio Savings Bank Act, because 12 C.F.R. §7.4001(a) includes loan origination fee in the definition of “interest” that may be exported from a national bank's home state. As a result of exporting the “interest” 135 from Ohio to Missouri, the National Bank of Ohio would not be subject to the “interest” restrictions set forth in Missouri law concerning loan origination fees.

If an insured depository institution exports “interest” 135 from its home state and makes no elections under the other available options, such as MFL doctrine, statutory election and preemption, the compliance assessment system will:
1. Run all of the nonexportable rules, the exportable fees rules (non exportable fees in these rules only), and the exportable paid to fees rules (exportable fees not paid to the lender and all non-exportable fees) under all applicable acts in the target state (property state).
2. Run all of the exportable rules, exportable fees rules (exportable fees in these rules only), and the exportable paid to fees rules (exportable fees paid to the lender in these rules only) under all applicable acts in the home state.
3. Not run the exportable rules under any applicable acts in the target state (property state). The definitions that apply to the exportation option 135 include Home State, Target State, Exportable Rule, Exportable Fees Rule and NonExportable Rule.

Preemption Option

Preemption authority for federal savings associations comes from sections 4(a) and 5(a) of the HOLA, 12 U.S.C. §1463(a), §1464(a); wherein the Office of Thrift Supervision (OTS) is authorized to promulgate regulations that preempt state laws affecting the operations of federal savings associations, to enable federal savings associations to conduct their operations in accordance with the best practices of thrift institutions in the United States, or to further other purposes of the HOLA. 12 C.F.R. §560.2. This preemption authority also applies to operating subsidiaries of federal savings associations. Preemption authority for national associations (national banks) comes from 12 U.S.C. §93a, 12 U.S.C. §371, 12 C.F.R. §§7.4008, 7.4009, 34.1, and 34.3, wherein the Office of the Comptroller of the Currency (OCC) is authorized to promulgate rules and regulations on a national bank's real estate lending power without state-imposed conditions. As matter of Federal law, national bank operating subsidiaries conduct their activities subject to the same terms and conditions as apply to the parent banks, except where Federal law provides otherwise. See 12 CFR §§5.34(e)(3), 7.4006, and 34.1(b). Thus, the OCC regulations apply to both national banks and their operating subsidiaries.

Preemption 145 is the ability of a national bank and a federal savings association to override certain types of state laws in lending and deposit taking activities. The national bank and federal savings association may apply this preemption authority 145 to all loans or only to certain types of loans. A subsidiary of a national bank may be treated as if it was the national bank. A subsidiary of a federal savings association may be treated as if it was the federal savings association.

Under a theory of complete or total federal preemption 145, a national bank or federal savings association may decide to make loans subject only to federal law and ignore state specific imposed requirements.
Example: If the national bank or federal savings association chooses to lend under a complete federal preemption theory, the institution will be limited to a very low interest rate (1% over the discount rate on 90-day commercial paper in effect at the Federal Reserve bank in the Federal Reserve district in which the institution is located or at the rate allowed by the laws of the State in which the institution is located, whichever is greater. However, the institution will not be subject to any additional fee or late charge restrictions.

Under a theory of partial preemption, a national bank and federal savings association may decide to abide by some state substantive laws but ignore others.
Example: A state specific law requires a mortgage lender subsidiary of a national bank or federal savings association to obtain a license to lend in that state. If the state law does not contain an exemption for such a subsidiary, the national bank or federal savings association may decide to use a partial federal preemption theory, and ignore the state law licensing requirements as it applies to their mortgage lender subsidiary. A national bank or federal savings association also may decide to pick and choose which state substantive laws may apply to it in a specific state.

Preemption is available to federal savings banks (and associations) and their operating subsidiaries, and to national banks and their operating subsidiaries

The compliance assessment system addresses the lender's choice concerning federal preemption 145. If the lender has a preemption election available to the lender and elects to use preemption 145, the compliance assessment system will, depending on the loan or loan type, (1) run only the rules that are part of the elected preemptions and (2) not run the rules that are preempted as a result of the lender's preemption elections.

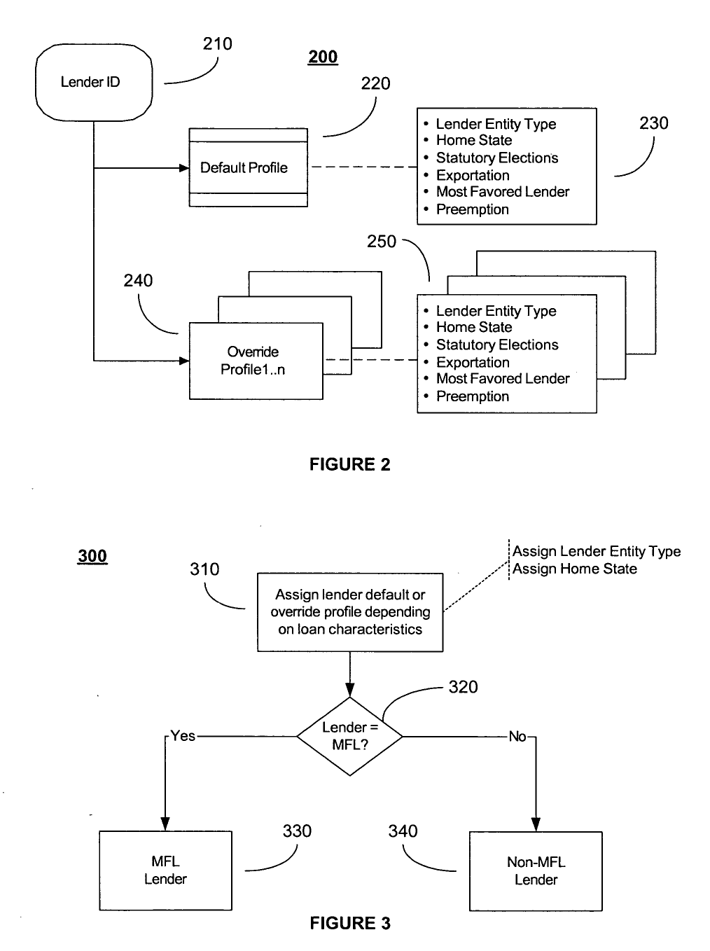

Turning to FIG. 2, FIG. 2 shows default and override lender profiles 200 used for determining designated sets of regulatory compliance rules available to the lender. A lender ID 210 identifies at least a default profile 220 identifying a unique lender entity type, home state, statutory elections, exportation, MFL doctrine and preemption 230. A lender may also set up override profiles 240 for different types of loans, each override profile 240 also identifying a lender entity type, home state, statutory elections, exportation, MFL doctrine and preemption 250. For example, a lender's default profile may be as a state licensed lender, such as when the lender is an operating subsidiary of a national bank and, without using preemption authority, would be subject to state mortgage lending licensing requirements. However, the lender may set up one override profile for all first lien loans where the lender entity type is set to “state licensed lender”. The lender may also set up another override profile for all subordinate lien loans where the lender entity type is set to “national bank”. If no override profiles exist, the default profile becomes the active profile. The system assigns values specified in the designated profile for lender entity type, home state if the entity is an insured depository institution, and MFL doctrine election availability in effect for the loan. Whether the lender is an entity that can use the MFL doctrine election determines the lender profile options available to evaluate against the loan.

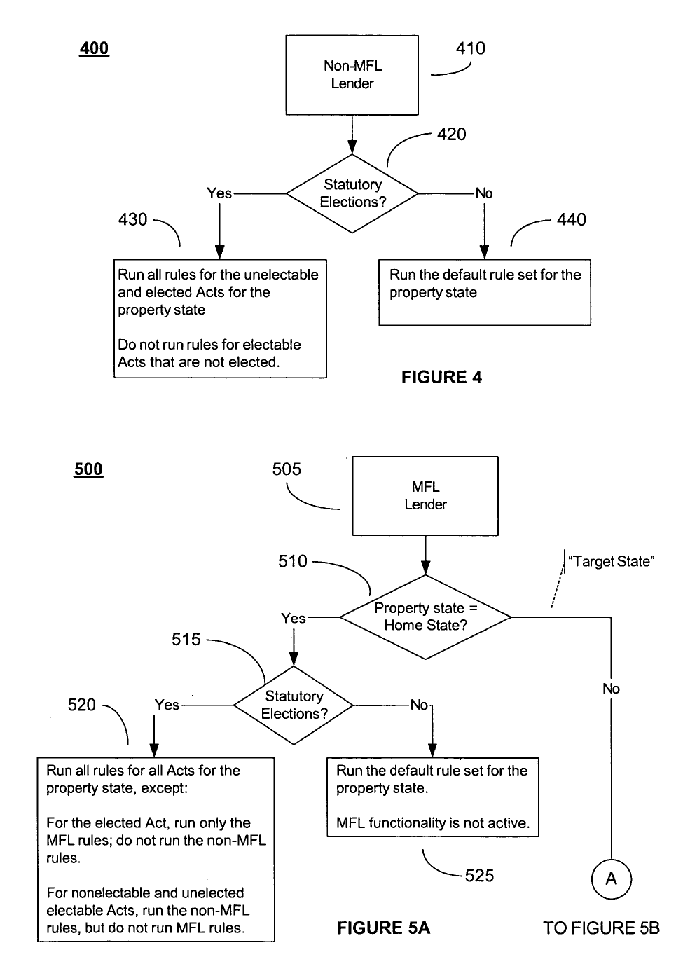

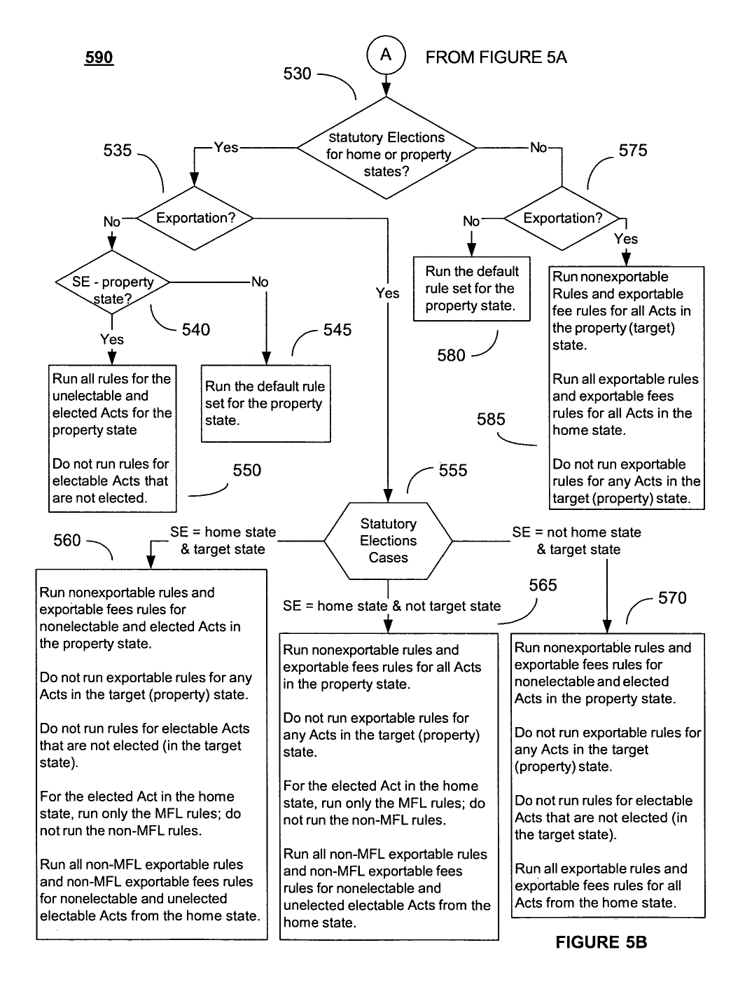

FIGS. 3, 4, 5A and 5B describe the compliance profile configuration processing functionality. Before the state reviewer (160 in FIG. 1) evaluates the subject loan, applicable acts are collected and their associated rules are evaluated against the pertinent aspects of the loan. The applicable act configuration for the specific loan under review falls intone of the cases described below, depending upon the lender's MFL status. The assumption for the acts is that they run if the act application rule or an overriding act election rule evaluates as “true”. Turning to FIG. 3, FIG. 3 shows a flow diagram 300 for a MFL determination from a default or override profile. A lender default or override profile 310 is assigned, depending on characteristics of a loan. If the lender's effective MFL attribute in the lender default or override profile 310 indicates that the lender is an entity that can use the MFL doctrine 320, the compliance profile configuration processing options are available as a MFL lender 330, as shown in FIGS. 5A and 5B. Otherwise, the compliance profile configuration processing options for a non-MFL lender 340 are available, as shown in FIG. 4.

Turning to FIG. 4, FIG. 4 shows a flow diagram 400 for statutory elections available to lender that is a non-MFL lender 410. The principle of federal preemption provides the benefits of the MFL doctrine and exportation rules to national banks and national savings banks. However, since statutory election is a benefit provided under the laws of some states, a non-MFL lender 410 may have the option of selecting or not selecting a statutory election if this benefit is provided under the laws of the state where the subject property is located. If the property state designated by a non-MFL lender 410 does not have a statutory election law or if a non-MFL lender 410 does not elect a statutory election in a state that does have a statutory election law 420, a default rule set is the basis for a compliance review 440. If the property state designated by a non-MFL lender 410 does have a statutory election law and if the non-MFL lender 410 selects a statutory election in that state 420, then all the rules for the unelectable and elected acts for that jurisdiction are used as the basis for a compliance review 430. None of the rules for the electable acts that were not elected are evaluated 430. A summary of applicable act collection cases for non-MFL lenders is shown in Table 2.

TABLE 2
APPLICABLE ACT COLLECTION CASES - NON MFL

| CASE | | ACTIONS | |
|---|---|---|---|
| 1: | Default - no | 1. | Run the default rule set for the property state. |
| | statutory | | |
| | elections, no | | |
| | exportation | | |
| 2: | Statutory | 1. | Run all rules for the nonelectable and elected |
| | election | | acts for the property state. |
| | | 2. | Do not run rules for electable acts that are |
| | | | not elected in the property state. |

Turning to FIG. 5A, FIG. 5A shows a flow diagram 500 for statutory elections available to a lender that is a MFL lender 505 where the property state is the same as the home state 510. If the property state is not the same as the home state 510, the flow diagram 590 shown in FIG. 5B is applicable to the MFL lender 505. The primary determination for a MFL lender 505 is whether the subject property is located in the home state or another state 510. If the property is located in the home state 510, a secondary determination is whether s statutory election is available to the lender 515. A statutory election may be available 515 even though exportation is not available. If there are no statutory elections available in the property state or if the lender does not select a statutory election that may be available 515, a default rule set for the property state 525 is used as the basis for a compliance review. In this case, MFL doctrine functionality is not active 525.

If there are statutory elections available in the property state and if the lender selects a statutory election that may be available 515, all rules for all acts in the property state are used as the basis for a compliance review for the property state 520, with the following exceptions: for elected acts, only the MFL rules are used and non-MFL rules are not used; for nonelectable and unelected acts, only the non-MFL rules are used and MFL rules are not used 520. A summary of applicable act collection cases for MFL lenders where the property state is not the home state is shown in Table 3.

TABLE 3
APPLICABLE ACT COLLECTION CASES - MFL
WHERE PROPERTY IS IN HOME STATE

| CASE | | ACTIONS | |
|---|---|---|---|
| 1: | Default - no | 1. | Run the default rule set for the property state. |
| | statutory | 2. | MFL functionality is not active. |
| | elections, no | | |
| | exportation | | |
| 2: | Statutory | 1. | Run all rules for all acts for the property state, |
| | election | | except: |
| | | | a. For the elected act, run only the MFL rules. |
| | | | Do not run the non-MFL rules. |
| | | | b. For nonelectable and unelected electable acts, |
| | | | run the non-MFL rules, but do not run MFL rules. |

Turning to FIG. 5B, FIG. 5B shows a flow diagram 590 for statutory elections 530 and exportation elections 535, 575 available to a lender that is a MFL lender where the property state is not the same as the home state (510 in FIG. 5A). For the cases where the property state is not the home state, statutory elections 530 and exportation 535, 575 may both be in effect, depending on the choices specified in the applicable profile. Where the property state is not the home state, the property state is referred to as the target state. If there are no statutory elections in the home state or property state 530 and exportation is not active 575, a default rule set for the property state 580 is used as the basis for a compliance review. If there are no statutory elections in the home-state or property state 530 and exportation is active 575, nonexportable rules and exportable fee rules for all acts in the property state, and all exportable rules and exportable fees rules for all acts in the home state 585 are used as the basis for a compliance review. Exportable rules for acts in the target state are not used 585.

If there are statutory elections in the property state 530, 540 and exportation is not active 535 in the target state, all rules for unelectable and elected acts in the property state 550 are used as a basis for a compliance review. Rules for electable acts that are not elected are not used 550. If there are statutory elections in the home state 530 but no statutory elections in the property state 540 and exportation is not active 535 in the target state, a default rule set for the property state 545 is used as a basis for a compliance review.

If there are statutory elections in the home state or property state 530 and exportation is not active 535 in the target state, three cases for statutory election are available 555. In a first case for determining compliance review where there is exportation 535 with statutory elections in both the home state and the target state 555, nonexportable rules and exportable fees rules for nonelected and elected acts in the target state are used, only MFL rules for elected acts in the home state are used, and all non-MFL exportable rules and non-MFL exportable fees rules for nonelectable and unelected electable acts from the home state are used. Exportable rules for any acts in the property state, rules for electable acts that are not elected in the target state, and non-MFL rules in the home state are not used. In a second case for determining compliance review where there is exportation 535 with statutory elections in the home state but not the target state 555, nonexportable rules and exportable fees rules for nonelectable and elected acts in the target state are used, only MFL rules for elected acts in the home state are used, and all non-MFL exportable rules and non-MFL exportable fees rules for nonelectable and unelected electable acts from the home state are used. Exportable rules for any acts in the property state and non-MFL rules in the home state are not used. In a third case for determining compliance review where there is exportation 535 with statutory elections in the target state but not the home state 555, nonexportable rules and exportable fee rules for nonelected and elected acts in the target state are used, and all non-MFL exportable rules and non-MFL exportable fees rules for nonelectable and unelected electable acts from the home state are used. Exportable rules for any acts in the property state and rules for electable acts that are not elected in the target state are not used. A summary of applicable act collection cases for MFL lenders where the property state is not the home state is shown in Table 4.

TABLE 4
APPLICABLE ACT COLLECTION CASES - MFL
WHERE PROPERTY IS NOT IN HOME STATE

| CASE | | ACTIONS | |
|---|---|---|---|
| 1: | Default - no statutory | 1. | Run the default rule set for the property state. |
| | elections, no | | |
| | exportation | | |
| 2: | Exportation without | 1. | Run all nonexportable rules and exportable fees rules for all acts |
| | statutory election | | in the target state. |
| | | 2. | Run all exportable rules and exportable fees rules for all acts |
| | | | from the home state. |
| | | 3. | Do not run the exportable rules in any of the acts in the target |
| | | | state. |
| 3: | Statutory election | 1. | Run all Rules for the nonelectable and elected acts for the |
| | without exportation | | property state. |
| | | 2. | Do not run rules for electable acts that are not elected. |
| 4: | Exportation with | 1. | Run only the nonexportable rules and exportable fees rules for |
| | statutory election in | | the nonelectable and elected acts for the target state. |
| | both the home state and | 2. | Do not run the exportable rules in any of the acts in the target |
| | target state | | state. |
| | | 3. | Do not run rules for electable acts that are not elected (in the |
| | | | target state). |
| | | 4. | For the elected act in the home state, run only the MFL rules; do |
| | | | not run the non-MFL rules. |
| | | 5. | Run all non-MFL exportable rules and non-MFL exportable |
| | | | fees rules for the nonelectable and unelected electable acts from |
| | | | the home state. |
| 5: | Exportation with | 1. | Run nonexportable rules and exportable fees rules for |
| | statutory election in the | | nonelectable and elected acts in the target state. |
| | home state but not in | 2. | Do not run exportable rules for any acts in the target (property) |
| | the target state | | state. |
| | | 3. | For the elected act in the home state, run only the MFL rules. |
| | | | Do not run the non-MFL rules. |
| | | 4. | Run all non-MFL exportable rules and non-MFL exportable |
| | | | fees rules for nonelectable and unelected electable acts from the |
| | | | home state. |
| 6: | Exportation with | 1. | Run nonexportable rules and exportable fees rules for |
| | statutory election in the | | nonelectable and elected acts in the target state. |
| | target state but not in | 2. | Do not run exportable rules for any acts in the target (property) |
| | the home state | | state. |
| | | 3. | Do not run rules for electable acts that are not elected in the |
| | | | target state. |
| | | 4. | Run all non-MFL exportable rules and non-MFL exportable |
| | | | fees rules for nonelectable and unelected electable acts from the |
| | | | home state. |

With regard to Table 4, when exportation is active, acts that are to be evaluated during the review, depending on whether there are statutory elections made in the home and target states, are specified in Table 5.

TABLE 5

| HOME | | | | | | | | |
|---|---|---|---|---|---|---|---|---|
| STATE | | | | | | | | |
| TARGET | ELECTION | | ELECTION | | NO ELECTION | | NO ELECTION | |
| STATE | ELECTION | | NO ELECTION | | ELECTION | | NO ELECTION | |
| RESULT | 1. | Elected act | 1. | Elected act | 1. | All acts in | 1. | All acts in |
| | | in home | | in home | | home state. | | home state. |
| | | state. Rule- | | state. Rule- | | Rule-level | | Rule-level |
| | | level MFL | | level MFL | | MFL flag is | | MFL flag is |
| | | flag is | | flag is | | inactive. | | inactive. |
| | | active. | | active. | | | | |
| | 2. | Elected acts | 2. | All acts in | 2. | Elected acts | 2. | All acts in |
| | | in target | | target state | | in target | | target state |
| | | state | | | | state | | |

When exportation to a target state is active, the get-fee and fees-not-allowed functions must treat “exportable” rules and fees differently, depending on whether the fee originates from the home state or the target state. The rule and fee handling in exportation are shown in Tables 6 and 7 below. Table 6 specifies the rule and fee handling for the case where the home state is the source of the rule and fee. Table 7 specifies the rule and fee handling for the case where the target state is the source of the rule and fee. In the “Result” row, “Evaluate” means to evaluate the rule. “Include” in the “Result” row means to include the fee in the applicable function calculations and “Exclude” means to leave the fee out of the calculations.

TABLE 6
RULES & FEES IN HOME STATE

| | | | | |
|---|---|---|---|---|
| RULE | Exportable Fees | Exportable Fees | NonExportable | NonExportable |
| FEE | Exportable | NonExportable | Exportable | NonExportable |
| RESULT | Evaluate & Include | Evaluate & Exclude | Do not evaluate | Do not evaluate |

TABLE 7
RULES & FEES IN TARGET (PROPERTY) STATE

| | | | | |
|---|---|---|---|---|
| RULE | Exportable Fees | Exportable Fees | NonExportable | NonExportable |
| FEE | Exportable | NonExportable | Exportable¹ | NonExportable |
| RESULT | Evaluate & Exclude | Evaluate & Include | Evaluate & Include | Evaluate & Include |

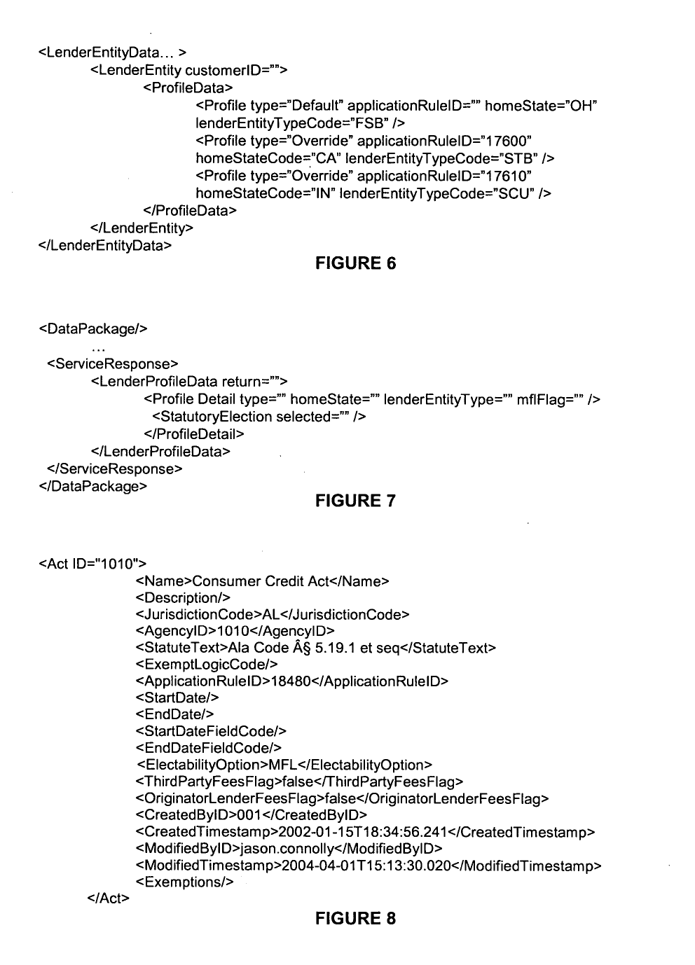

Turning to FIG. 6, FIG. 6 shows an XML representation of a lender identity. The lender identity XML includes the default and override profiles for the identified lender.

Turning to FIG. 7, FIG. 7 shows an XML representation of a data package. The data package XML includes home state, lender entity type, MFL status, and statutory election selection.

Turning to FIG. 8, FIG. 8 shows an XML representation of an act. The act XML includes the act name, description, jurisdiction, agency identification, statute text, application rule identification, etc.

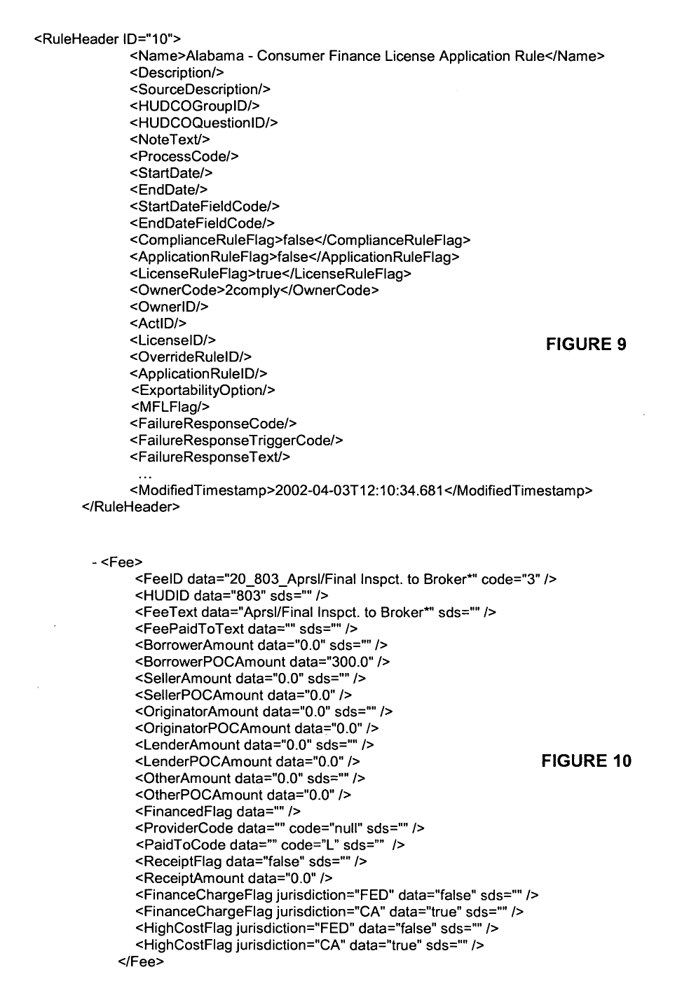

Turning to FIG. 9, FIG. 9 shows an XML representation of a rule header. The rule header XML includes the name of the act from which the rule is derived, a description, HUDCO group identification, etc.

Turning to FIG. 10, FIG. 10 shows an XML representation of a fee. The fee XML includes fee identification data, HUD identification, fee text data, borrower amount data, seller amount data, etc.

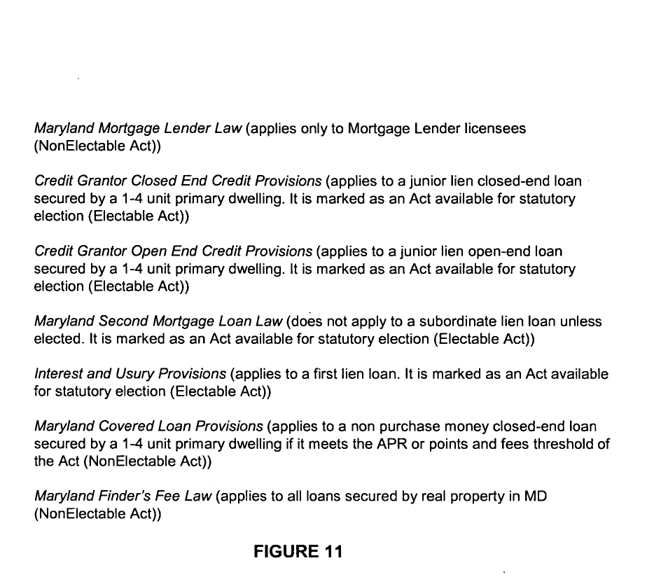

Turning to FIG. 11, FIG. 11 lists the acts that may be available as the basis for compliance review for the state of Maryland. The listed acts may be used in the following illustrative examples of the compliance profile configuration processing functionality.

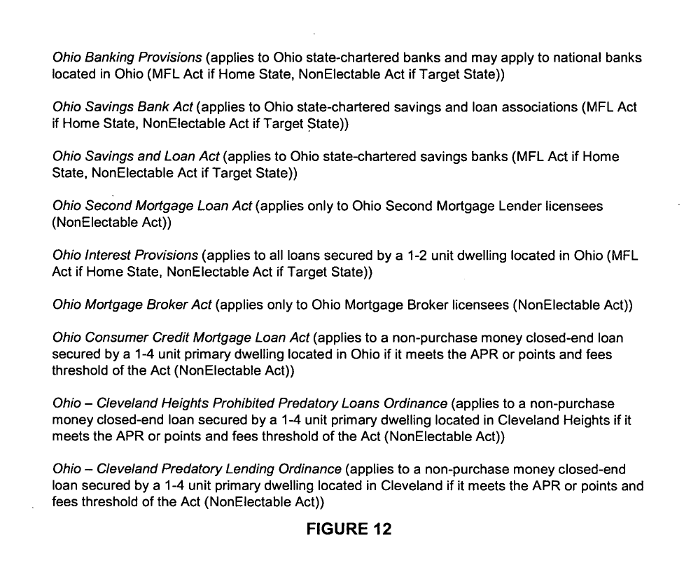

Turning to FIG. 12, FIG. 12 lists the acts that may be available as the basis for compliance review for the state of Ohio. The listed acts may be used in the following illustrative examples of the compliance profile configuration processing functionality.

As a first illustrative example, consider a non-MFL lender located in Maryland that wants to make a loan where the property is also located in Maryland, without relying on statutory election. Thus the conditions are “home state=property state, no statutory election”. This scenario is depicted as reference number 440 in FIG. 4. All applicable Maryland acts from which the computer-encoded compliance rules for Maryland are derived are listed in FIG. 11. The compliance profile configuration processing system will run the default computer-encoded compliance rules set derived from the following Maryland acts for a depository institution located in Maryland:
Credit Grantor Closed End Credit Provisions
Maryland Covered Loan Provisions
Maryland Finder's Fee Law

As a second illustrative example, consider the non-MFL lender located in Maryland described above that wants to make a loan where the property is also located in Maryland, but wishes to rely on a statutory election. Thus the conditions are “home state=property state, statutory election”. This scenario is depicted as reference number 430 in FIG. 4. All applicable Maryland acts from which the computer-encoded compliance rules for Maryland are derived are listed in FIG. 11. The compliance profile configuration processing system will run a computer-encoded compliance rules set derived from the Maryland elected acts and all of the nonelectable acts. The system will not run any rules under the unelected electable acts. If the Maryland institution makes a statutory election to use the Maryland Second Mortgage Loan Law for its subordinate lien loans in its lender profile, then the compliance system will apply a computer-encoded compliance rules set derived from the following acts in Maryland to reflect an override lender profile:
Maryland Second Mortgage Loan Law
Maryland Covered Loan Provisions
Maryland Finder's Fee Law

As a third illustrative example, if a depository institution does not make a MFL doctrine election in the home state, does not make a statutory election in the target state, and the depository institution exports the “interest rate” from its home state, the compliance profile configuration processing system will:
1. Run all of the nonexportable rules, the exportable fees rules (non exportable fees in these rules only), and the exportable paid to fees rules (exportable fees not paid to lender and all non-exportable fees) under all applicable acts in the target state.
2. Run all of the exportable rules, exportable fees rules (exportable fees in these rules only), and the exportable paid to fees rules (exportable fees paid to lender in these rules only) under all applicable acts in the home state.
3. Do not run the exportable rules under all applicable acts in the target state.
   This scenario is depicted in reference number 585 in FIG. 5B. Consider a depository institution located in Ohio that wants to make a loan where the property is located in Maryland, does not wish to make a statutory election or MFL election, but wishes to export Ohio fees. Thus the conditions are “home state≠property state, exportation, no MFL election and no statutory election”. All applicable Maryland acts from which the computer-encoded compliance rules for Maryland are derived are listed in FIG. 11 and all applicable Ohio acts from which the computer-encoded compliance rules for Ohio are derived are listed in FIG. 12. The compliance profile configuration processing system will first run a computer-encoded compliance rules set derived from the following Ohio acts for an Ohio state-chartered bank or national bank located in Ohio:
   Ohio Banking Provisions
   Ohio Interest Provisions
   Ohio Consumer Credit Mortgage Loan Act
   Ohio—Cleveland Heights Prohibited Predatory Loans Ordinance
   Ohio—Cleveland Predatory Lending Ordinance

Within these acts, the following Table 8 through Table 12, respectively, describes what rules will run or not run as a result of exportation in the home state.

TABLE 8
OHIO - BANKING PROVISIONS

| | Non | | | Exportable | | |
|---|---|---|---|---|---|---|
| | Exportable | Exportable | Exportable | Paid to | Exportable | |
| Rule Name | Rule | Rule | Fees Rule | Fees Rule | Fee | Failure/Warning |
| Maximum APR: | No | Yes | No | No | No | Yes. Note rate is |
| Maximum APR cannot | | | | | | 26% so APR exceeds |
| exceed 25%. | | | | | | 25%. |

TABLE 9
OHIO - INTEREST PROVISIONS

| | Non | | | Exportable | | |
|---|---|---|---|---|---|---|
| | Exportable | Exportable | Exportable | Paid to | Exportable | |
| Rule Name | Rule | Rule | Fees Rule | Fees Rule | Fee | Failure/Warning |
| Ohio - Maximum Lender | No | No | Yes | No | Yes/No | Yes. This rule will |
| Fees (Interest) (junior liens | | | | | | run in the home state |
| only, fees paid to the | | | | | | but only for those |
| lender cannot exceed 2% | | | | | | fees that are |
| of the loan amount) | | | | | | exportable fees. The |
| | | | | | | exportable fees paid |
| | | | | | | to the lender (loan |
| | | | | | | origination fee) |
| | | | | | | exceed 2% of the |
| | | | | | | loan amount. |
| Ohio - Prepayment Penalty | No | Yes | No | No | No | Yes. Exportable rule |
| Warning (Interest) | | | | | | & Ohio = home state. |
| Ohio - Usury (Interest): | No | Yes | No | No | No | No. Even though it is |
| Maximum interest rate | | | | | | an exportable rule & |
| cannot exceed 8% over the | | | | | | Ohio = home state, |
| discount rate on 90-day | | | | | | this limitation does |
| commercial paper in effect | | | | | | not apply the Ohio |
| at the Federal Reserve | | | | | | state-chartered banks. |
| Bank in the 4^{th} Federal | | | | | | |
| Reserve District at the loan | | | | | | |
| disbursement date. | | | | | | |

TABLE 10
OHIO CONSUMER CREDIT MORTGAGE LOAN ACT

| | Non | | | Exportable | | |
|---|---|---|---|---|---|---|
| | Exportable | Exportable | Exportable | Paid to | Exportable | |
| Rule Name | Rule | Rule | Fees Rule | Fees Rule | Fee | Failure/Warning |
| All Rules - If APR or | Yes | No | No | No | No | No. Rules under this |
| “points and fees” threshold | | | | | | act are non- |
| met. | | | | | | exportable rules & |
| | | | | | | Ohio = home state. |

TABLE 11
OHIO - CLEVELAND HEIGHTS PROHIBITED PREDATORY LOANS ORDINANCE

| | Non | | | Exportable | | |
|---|---|---|---|---|---|---|
| | Exportable | Exportable | Exportable | Paid to | Exportable | |
| Rule Name | Rule | Rule | Fees Rule | Fees Rule | Fee | Failure/Warning |
| All Rules - If APR or | Yes | No | No | No | No | No. Rules under this |
| “points and fees” threshold | | | | | | act are non- |
| met. | | | | | | exportable rules & |
| | | | | | | Ohio = home state. |

TABLE 12
OHIO - CLEVELAND PREDATORY LENDING ORDINANCE

| | Non | | | Exportable | | |
|---|---|---|---|---|---|---|
| | Exportable | Exportable | Exportable | Paid to | Exportable | |
| Rule Name | Rule | Rule | Fees Rule | Fees Rule | Fee | Failure/Warning |
| All Rules - If APR or | Yes | No | No | No | No | No. Rules under this |
| “points and fees” threshold | | | | | | act are non |
| met. | | | | | | exportable rules & |
| | | | | | | Ohio = home state. |

The compliance profile configuration processing system will then run a computer-encoded compliance rules set derived from the following Maryland acts:
Credit Grantor Closed End Credit Provisions
Maryland Covered Loan Provisions
Maryland Finder's Fee Law

Within these acts, the following Table 13 through Table 15 describes what rules will run or not run as a result of exportation in the target state of Maryland.

TABLE 13
MARYLAND CREDIT GRANTOR CLOSED END PROVISIONS

| | Non | | | Exportable | | |
|---|---|---|---|---|---|---|
| | Exportable | Exportable | Exportable | Paid to | Exportable | |
| Rule Name | Rule | Rule | Fees Rule | Fees Rule | Fee | Failure/Warning |
| Maximum Broker/Lender | No | No | No | Yes | No/Yes | Yes. The broker fee |
| Fees - Combined broker & | | | | | | of $10,500 exceeds |
| lender fees may not exceed | | | | | | 10%. loan origination |
| 10% of the loan amount. | | | | | | fee ignored, because |
| | | | | | | exportable fee & |
| | | | | | | Maryland = target |
| | | | | | | state. |
| Usury Rate | No | Yes | No | No | No | No. Exportable rule |
| | | | | | | & Maryland = target |
| | | | | | | state. |
| Prepayment Penalty is Not | No | Yes | No | No | No | No. There is a |
| Allowed | | | | | | prepayment penalty, |
| | | | | | | but Maryland = target |
| | | | | | | state. |
| Balloon Loan Warning | Yes | No | No | No | No | Yes. Balloon |
| | | | | | | payment, non |
| | | | | | | exportable rule, & |
| | | | | | | Maryland = target |
| | | | | | | state. |
| Days Used for Interest | No | Yes | No | No | No | No |
| Calculation: (minimum | | | | | | |
| 360) | | | | | | |
| Maximum Late Fee: | No | Yes | No | No | No | No |
| Cannot exceed the greater | | | | | | |
| of $5 or 10%. | | | | | | |
| Minimum Grace Period: | No | Yes | No | No | No | No |
| Cannot be less than 15 | | | | | | |
| days. | | | | | | |
| Fees Not Allowed: | No | No | Yes | No | No. None | Yes. Inspection fee is |
| Reconveyance Fee (not | | | | | of these | not exportable & |
| allowed if paid by | | | | | fees are | Maryland = target |
| borrower to lender), | | | | | exportable. | state. |
| Inspection Fee, and Field | | | | | | |
| Review Fee. | | | | | | |

TABLE 14
MARYLAND COVERED LOAN PROVISIONS

| | Non | | | Exportable | | |
|---|---|---|---|---|---|---|
| | Exportable | Exportable | Exportable | Paid to | Exportable | |
| Rule Name | Rule | Rule | Fees Rule | Fees Rule | Fee | Failure/Warning |
| All Rules - If the APR or | Yes | No | No | No | No | Yes. Rules under this |
| “points and fees” threshold | | | | | | act are non |
| is met. | | | | | | exportable rules & |
| | | | | | | Maryland = target |
| | | | | | | state. |

TABLE 15
MARYLAND FINDER'S FEE LAW

| | Non | | | Exportable | | |
|---|---|---|---|---|---|---|
| | Exportable | Exportable | Exportable | Paid to | Exportable | |
| Rule Name | Rule | Rule | Fees Rule | Fees Rule | Fee | Failure/Warning |
| Fees Not Allowed: | No | No | Yes | No | No | Yes. Intangible fee is |
| Intangible Tax not are | | | | | | non exportable & |
| allowed if paid by the | | | | | | Maryland = target |
| Borrower. | | | | | | state. |
| Broker Fees Must Not | Yes | No | No | No | No | Yes. Non exportable |
| Exceed 8% Of Loan | | | | | | rule & Maryland = |
| Amount | | | | | | target state. |

Although the present invention has been described in detail with reference to certain preferred embodiments, it should be apparent that modifications and adaptations to those embodiments might occur to persons skilled in the art without departing from the spirit and scope of the present invention.

What is claimed is:

1. A computer-implemented method for compliance profile configuration and application, comprising the steps of:
designating a compliance profile comprising one or more options;
deriving a set of computer-encoded compliance rules based on the one or more options in the compliance profile;
assessing regulatory compliance of a lender compliance review file in a compliance assessment computer system by automatically comparing the lender compliance review file with the designated set of computer-encoded compliance rules stored in a regulatory compliance rules repository;
producing a compliance assessment result file indicating subject areas in the compliance review file that are compliant and noncompliant with the derived set of computer-encoded compliance rules; and
displaying the subject areas that are compliant and noncompliant to a user.

2. The method of claim 1, further comprising selecting the one or more options in the compliance profile from the group of options consisting of lender entity type, home state, statutory election, exportation, most favored lender and preemption.

3. The method of claim 2, wherein the lender entity type option is selected from the group consisting of a national bank, a federal savings bank, a federal credit union, a state chartered bank, a state chartered savings bank, a state chartered savings and loan association, a state chartered credit union, and a non-depository licensed lender.

4. The method of claim 2, wherein the home state option comprises the state where the principal office of a depository institution is located.

5. The method of claim 2, wherein the statutory election option comprises a designated statutorily electable act allowable under a state law.

6. The method of claim 2, wherein the exportation option comprises a designated interest rate provision from a home state of a depository institution for determining an exportable chargeable interest rate in a target state.

7. The method of claim 2, wherein the most favored lender option comprises a designated preferred interest rate provision available to applicable depository institutions that makes available to the applicable depository institutions interest rates that are available to other lending institutions within a state.

8. The method of claim 2, wherein the preemption option comprises a designated exemption available to national banks and federal savings associations from certain types of state laws in lending and deposit taking activities.

9. The method of claim 2, wherein the lender entity type and home state options determine other options that are available to a lender.

10. The method of claim 1, wherein the step of deriving a set of computer-encoded compliance rules comprises the step of deriving computer-encoded compliance rules from elected statutorily electable acts and applicable unelectable acts under state law.

11. The method of claim 1, wherein the step of deriving a set of computer-encoded compliance rules comprises the step of deriving computer-encoded compliance rules from law in a lender's home state for determining a chargeable interest rate under the most favored lender doctrine.

12. The method of claim 11, wherein the derived computer-encoded compliance rules are derived from the terms of the designated most favored lender elected home state act that are material to the determination of the chargeable interest rate.

13. The method of claim 1, wherein the step of deriving a set of computer-encoded compliance rules comprises the step of deriving computer-encoded compliance rules from compliance requirements of a home state that are material to determining an exportable chargeable interest rate applicable in a target state.

14. The method of claim 1, wherein the step of deriving a set of computer-encoded compliance rules comprises the step of deriving computer-encoded compliance rules from a preemption election to override certain types of laws in lending and deposit taking activities.

15. The method of claim 1, wherein, if a statutory election option in the designated compliance profile is elected and a most favored lender option in the designated compliance profile is not elected, the derived set of computer-encoded compliance rules comprises all computer-encoded compliance rules derived from unelectable and elected electable acts of a property state.

16. The method of claim 1, wherein, if a statutory election option in the designated compliance profile is not elected and a most favored lender option in the designated compliance profile is not elected, the derived set of computer-encoded compliance rules comprises a default computer-encoded compliance rule set derived from acts of a property state.

17. The method of claim 1, wherein, if a statutory election option in the designated compliance profile is elected, a property state is the same as a home state, and a most favored lender option in the designated compliance profile is elected, the derived set of computer-encoded compliance rules comprises all computer-encoded compliance rules derived from all acts of a property state, except only most favored lender rules derived from an elected act and non most favored lender rules derived from nonelectable and unelected electable acts.

18. The method of claim 1, wherein, if a statutory election option in the designated compliance profile is not elected, a property state is the same as a home state and a most favored lender option in the designated compliance profile is elected, the derived set of computer-encoded compliance rules comprises a default computer-encoded compliance rule set derived from acts of the property state.

19. The method of claim 1, wherein, if a statutory election option in the designated compliance profile is elected for a property state, the property state is not the same as a home state, a most favored lender option in the designated compliance profile is elected, and an exportation option in the designated compliance profile is not elected, the derived set of computer-encoded compliance rules comprises all computer-encoded compliance rules derived from unelectable and elected acts of the property state.

20. The method of claim 1, wherein, if a statutory election option in the designated compliance profile is elected, a property state is not the same as a home state, a most favored lender option in the designated compliance profile is elected, an exportation option in the designated compliance profile is not elected, and the statutory election option in the designated compliance profile is not elected for the property state, the derived set of computer-encoded compliance rules comprises a default computer-encoded compliance rule set derived from acts of the property state.

21. The method of claim 1, wherein, if a statutory election option in the designated compliance profile is elected, a property state is not the same as a home state, a most favored lender option in the designated compliance profile is elected, an exportation option in the designated compliance profile is elected, and the statutory election option in the designated compliance profile is for the home state and a target state is elected, the derived set of computer-encoded compliance rules comprises:
nonexportable computer-encoded compliance rules and exportable computer-encoded compliance fee rules derived from nonelectable and elected acts of the property state;
most favored lender computer-encoded compliance rules derived from an elected act of the home state; and
all non most favored lender exportable computer-encoded compliance fee rules derived from nonelectable and unelected electable acts of the home state.

22. The method of claim 1, wherein, if a statutory election option in the designated compliance profile is elected, a property state is not the same as a home state, a most favored lender option in the designated compliance profile is elected, an exportation option in the designated compliance profile is elected, and the statutory election designation is for the home state and not for a target state, the derived set of computer-encoded compliance rules comprises:
nonexportable computer-encoded compliance rules and exportable computer-encoded compliance fee rules derived from all acts in the property state;
most favored lender computer-encoded compliance rules derived from an elected act in the home state; and
all non most favored lender exportable computer-encoded compliance rules and non most favorable lender exportable computer-encoded compliance fee rules derived from nonelectable and unelected electable acts from the home state.

23. The method of claim 1, wherein, if a statutory election option in the designated compliance profile is elected, a property state is not the same as a home state, a most favored lender option in the designated compliance profile is elected, an exportation option in the designated compliance profile is elected, and the statutory election option is not for the home state and for a target state, the derived set of computer-encoded compliance rules comprises:
nonexportable computer-encoded compliance rules and exportable computer-encoded compliance fee rules derived from nonelectable and elected acts of the property state; and
all exportable computer-encoded compliance rules and exportable computer-encoded compliance fee rules derived from all acts of the home state.

24. The method of claim 1, wherein, if a statutory election option in the designated compliance profile is not elected, a property state is not the same as a home state, a most favored lender option in the designated compliance profile is elected, and an exportation option in the designated compliance profile is not elected, the derived set of computer-encoded compliance rules comprises a default rule set of computer-encoded compliance rules derived from acts of the property state.

25. The method of claim 1, wherein, if a statutory election option in the designated compliance profile is not elected, a property state is not the same as a home state, a most favored lender option in the designated compliance profile is elected, and an exportation option in the designated compliance profile is elected, the derived set of computer-encoded compliance rules comprises:
nonexportable computer-encoded compliance rules and exportable computer-encoded compliance fee rules derived from all acts in the property state; and
all exportable computer-encoded compliance rules and exportable computer-encoded compliance fee rules derived from all acts in the home state.

26. The method of claim 1, further comprising assigning a lender default profile and lender override profiles to a lender based on loan characteristics.

27. A computer-readable medium containing instructions for controlling a computer system to implement the method of claim 1.

28. A computer-based system for compliance profile configuration and application, comprising:
means for designating a compliance profile configuration comprising one or more options;
means for deriving a set of computer-encoded compliance rules based on the one or more options in the compliance profile;
means for assessing regulatory compliance of a lender compliance review file in a compliance assessment computer system by automatically comparing the lender compliance review file with the designated set of computer-encoded compliance rules stored in a regulatory compliance rules repository;
means for producing a compliance assessment result file indicating subject areas in the compliance review file that are compliant and noncompliant with the derived set of computer-encoded compliance rules; and
a user interface for displaying the subject areas that are compliant and noncompliant to a user.

29. The system of claim 28, wherein the one or more options in the designated compliance profile is selected from the group of options consisting of lender entity type, home state, statutory election, exportation, most favored lender and preemption.

30. The system of claim 29, wherein the lender entity type option is selected from the group consisting of a national bank, a federal savings bank, a federal credit union, a state chartered bank, a state chartered savings bank, a state chartered savings and loan association, a state chartered credit union, and a non-depository licensed lender.

31. The system of claim 29, wherein the home state option is elected from the state where the principal office of a depository institution is located.

32. The system of claim 29, wherein the statutory election option is an elected statutorily electable act allowable under a state law.

33. The system of claim 29, wherein the exportation option is an elected interest rate provision from a home state of a depository institution for determining an exportable chargeable interest rate in a target state.

34. The system of claim 29, wherein the most favored lender option is an elected preferred interest rate provision available to applicable depository institutions that makes available to the applicable depository institutions interest rates that are available to other lending institutions within a state.

35. The system of claim 29, wherein the preemption option is an elected exemption available to national banks and federal savings associations from certain types of state laws in lending and deposit taking activities.

36. The system of claim 29, wherein the elected lender entity type and home state options determine other options that are available to a lender.

37. The system of claim 28, wherein the means for deriving a set of computer-encoded compliance rules comprises a compliance profile configuration processing function for customizing the designated set of computer-encoded compliance rules based on the designated compliance profile.

38. The system of claim 28, wherein the means for assessing regulatory compliance of a lender compliance review file comprises:
a state reviewer for executing the compliance profile configuration processing functions; and
a rule engine for executing get fees and fees not allowed functions.

39. The system of claim 28, further comprising acts, rules and fee objects categorized and identified according to statutory elections, exportation, most favored lender doctrine and preemption.

40. A computer-implemented method for compliance profile configuration and application, comprising the steps of:
reading a compliance profile associated with a lender compliance review file for determining lender entity type election, home state election, statutory elections, exportation elections, most favored lender elections and preemption elections;
processing the compliance profile for selecting a computer-encoded compliance rule set derived from home state acts, property state acts, target state acts, and preemptions of acts determined by the compliance profile;
accessing the computer-encoded rules set from a compliance rules repository;
comparing the lender compliance review file with the computer-encoded compliance rule set in a compliance assessment computer system;
generating a compliance assessment result file for indicating subject areas of compliance and noncompliance; and
displaying the subject areas of compliance and noncompliance to a user.

41. The method of claim 40, wherein the step of processing the compliance profile further comprises the steps of:
accessing rules sets based on the statutory election if a no most favored lender election is determined;
accessing rule sets based on the statutory election if a most favored lender election is determined and a property state is the same as a home state;
accessing rule sets based on whether a statutory election is made for a property state if exportation is not elected, if a most favored lender election is determined and the property state is not the same as the home state;
accessing rule sets based on whether a statutory election is made in a home state and a target state, if exportation is elected, if a most favored lender election is determined and the property state is not the same as the home state; and
accessing rule sets based on whether exportation is elected, if a statutory election is made in a target state, if a most favored lender election is determined and the property state is not the same as the home state.

42. The method of claim 40, wherein the step of reading a compliance profile for determining a statutory election comprises the step of designating a statutorily electable act allowable under a state law.

43. The method of claim 40, wherein the step of reading a compliance profile for determining a most favored lender election comprises the step of designating a home state law for determining a chargeable interest rate in a loan.

44. The method of claim 40, wherein the step of reading a compliance profile for determining an exportation election comprises the step of reading a compliance profile for designating a home state law for determining an exportable chargeable interest rate and other exportable interest rate provisions, and applying the rate and provisions in a target state.

45. The method of claim 40, wherein the step of reading a compliance profile for determining a lenders election to take advantage of preemptions available to the lender comprises the step of designating computer-encoded compliance rules derived from the preemptions elected.

46. A computer-readable medium containing instructions for controlling a computer system to implement the method of claim 40.
